(19) United States
(12) Patent Application Publication
(10) Pub. No.: US 2004/0100372 A1
(43) Pub. Date: May 27, 2004

(54) Convenience high-brightness breakdown alarm lamp of car

(76) Inventor: Chung-Ho Yang, Hsi Chih City (TW)

Correspondence Address: BROWDY AND NEIMARK, P.L.L.C., 624 NINTH STREET, NW, SUITE 300, WASHINGTON, DC, 20001-5303, US

(21) Appl. No.: 10/303,767

(22) Filed: Nov. 26, 2002

(51) Int. Cl. B60Q 7/00

(52) U.S. Cl. 340/473; 340/908

(57) ABSTRACT

A convenience high-brightness breakdown alarm lamp of car comprises a base, a circuit unit, a light source, and a lampshade. The circuit unit is disposed in the base. The light source is electrically connected to the circuit unit so that the required electricity can be inputted to the light source. The lampshade is made of transparent material, and is connected with the base. The light source is received in the lampshade. The breakdown alarm lamp has a high brightness and a better alarming effect, and can be placed conveniently.

### FIELD OF THE INVENTION

The present invention relates to a convenience high-brightness breakdown alarm lamp of car and, more particularly, to an alarm lamp, which can be placed on a car, and has a light source for emitting out high-brightness light to have a better alarming effect.

### BACKGROUND OF THE INVENTION

Generally, when a car breaks down on road, it is necessary to erect an alarm rack at an appropriate distance behind the car to alarm rear cars, hence preventing them from bumping the broken-down car.

As shown in FIG. 1, a conventional breakdown alarm rack of car comprises two sets of sideboards 100, a bottom rack board 101, and a rack board 102. The two sets of sideboards 100 and the bottom rack board 101 form a triangular frame with light-reflecting sheets 103 and 104 disposed at appropriate regions of the front face thereof. The rack board 102 is disposed at the bottom of the bottom rack board 101 to support the sideboards 100 and the bottom rack board 101 to stand erect.

As shown in FIG. 2, the conventional breakdown alarm rack can be erected at an appropriate distance behind a broken-down car 200 to alarm other cars. When car lights illuminate the breakdown alarm rack, the alarming effect can be enhanced through the light-reflecting effect of the light-reflecting sheets 103 and 104.

However, if the above conventional breakdown alarm rack is used at a road turn, lights of rear cars cannot illuminate the breakdown alarm rack so as to lose the alarming effect. Besides, when it rains, snows or fogs, because the brightness of the reflected light from the light-reflecting sheets is insufficient, the alarming effect is badly affected. Moreover, the conventional breakdown alarm rack also has the problem of inconvenient placement.

Accordingly, the above conventional breakdown alarm rack of car, has inconvenience and drawbacks in practical use. The present invention aims to resolve the problems in the prior art.

### SUMMARY AND OBJECTS OF THE PRESENT INVENTION

The primary object of the present invention is to provide a convenience high-brightness breakdown alarm lamp of car, which has a light source for emitting out high-brightness light without the need of illumination of light from rear cars. A better alarming effect can thus be accomplished. Moreover, a better alarming effect can similarly be accomplished especially when used at a road turn or when it rains, snows or fogs.

Another object of the present invention is to provide a convenience high-brightness breakdown alarm lamp of car, which makes use of a magnet to adhere to a broken-down car to facilitate placement thereof.

To achieve the above objects, the present invention provides a convenience high-brightness breakdown alarm lamp of car, which comprises a base, a circuit unit, a light source, and a lampshade. The circuit unit is disposed in the base. The light source is electrically connected to the circuit unit so that the required electricity can be provided for the light source. The lampshade is made of transparent material, and is connected with the base. The light source is received in the lampshade.

The various objects and advantages of the present invention will be more readily understood from the following detailed description when read in conjunction with the appended drawings, in which:

### BRIEF DESCRIPTION OF DRAWING

FIG. 1 is a perspective assembly view of a conventional breakdown alarm rack of car;

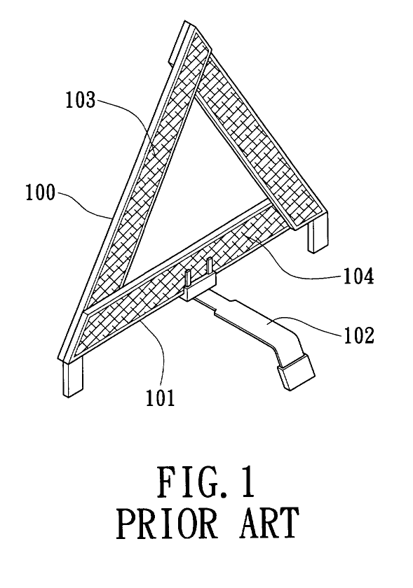

FIG. 2 is a diagram showing the use state of a conventional breakdown alarm rack of car;

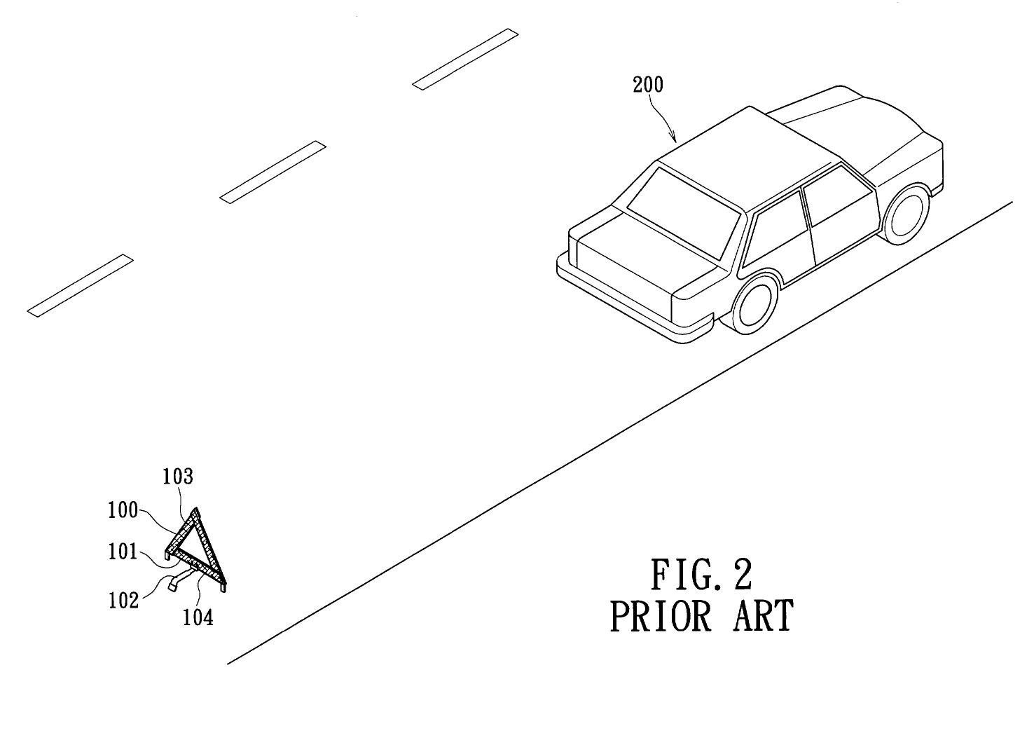

FIG. 3 is an exploded perspective view of a breakdown alarm lamp of car of the present invention;

FIG. 4 is perspective assembly view of a breakdown alarm lamp of car of the present invention; and

FIG. 5 is a diagram showing the use state of a breakdown alarm lamp of car of the present invention.

### DETAILED DESCRIPTION OF PREFERRED EMBODIMENT

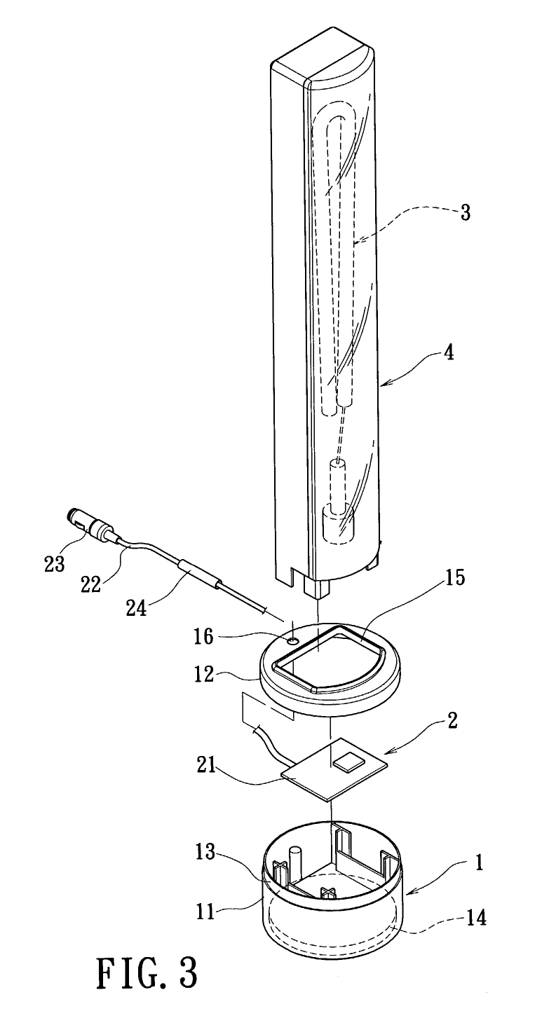

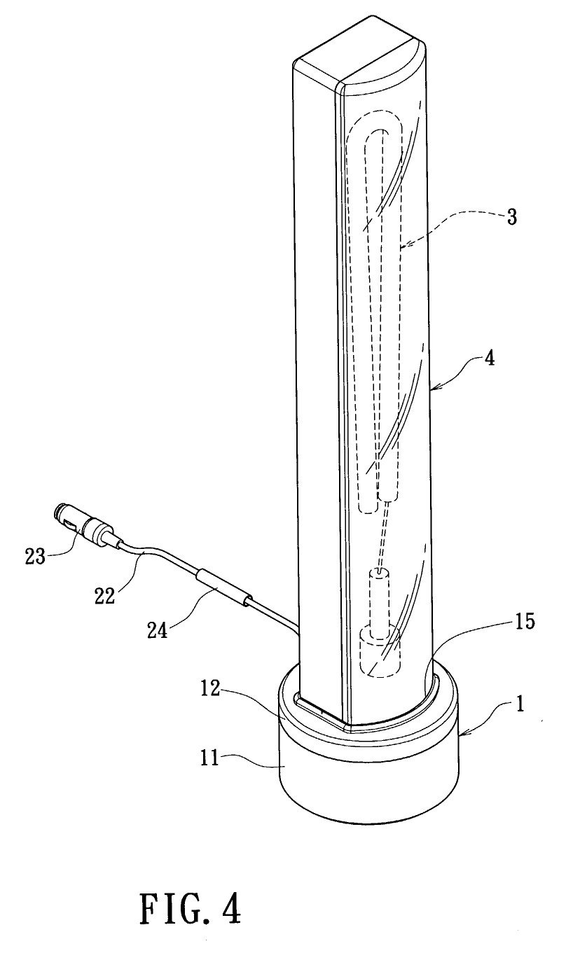

As shown in FIGS. 3 and 4, the present invention provides a convenience. high-brightness breakdown alarm lamp of car, which comprises a base 1, a circuit unit 2, a light source 3, and a lampshade 4. The base 1 is made of plastic material, and comprises a housing 11 and a cover body 12. The housing 11 is a hollow shell body, whose one side is open and has a connection portion 13 of a smaller outer diameter. The cover body 12 can be connected at the connection portion 13. The housing 11 and the cover body 12 can be assembled together after the circuit unit 2 is assembled in the base 1. Adhesive injection can be performed between the housing 11 and the cover body 12. A magnet 14 is also fixed at the housing 11 of the base 1 to adhere to a car through magnetic attraction. An assembly hole 15 and a line-out hole 16 are disposed at the cover body 12 of the base 1. The shape of the assembly hole 15 corresponding to the shape of the lampshade 4 to facilitate assembly of the lampshade 4.

The circuit unit 2 comprises a circuit board 21 and a power line 22. The circuit board 21 is disposed in the base 1. One end of the power line 22 is electrically connected to the circuit board 21, and the other end thereof protrudes from the line-out hole 16 of the base 1. The other end of the power line 22 is also connected to a car lighter plug 23, which is plugged into a car lighter socket to provide the required electricity for the circuit unit 2. A bushing 24 can be slipped outside the power line 22. When the power line 22 passes through between a glass window and a window frame of a car, the bushing 24 can be clamped between the glass window and the window frame to fix the power line 22 and prevent the power line 22 from damage because of being clamped between the glass window and the window frame.

The light source 3 can be any light-emitting device like a neon lamp, a light-emitting diode (LED) or a fluorescent lamp. The type of the light source 3 is not limited, but, a neon lamp having the highest brightness is preferred. The light source 3 can also be designed to have a “!” shape according to necessity to have a better alarming effect. The light source 3 is disposed outside the base 1. The light source 3 is electrically connected to the circuit board 21 of the circuit unit 2 so that the required electricity can be inputted to the light source 3.

The lampshade 4 is made of transparent plastic material, and is a long hollow shell body, whose one end is open. The lampshade 4 is slipped outside the light source 3 to protect it. The open end of the lampshade 4 is inserted into the assembly hole 15 of the base 1, and is properly fixed to connect the lampshade 4 with the base 1. The light source 3 can be received in the lampshade 4, and light generated by the light source 3 can be emitted out through the lamp shape 4. The convenience high-brightness breakdown alarm lamp of car of the present invention is thus formed.

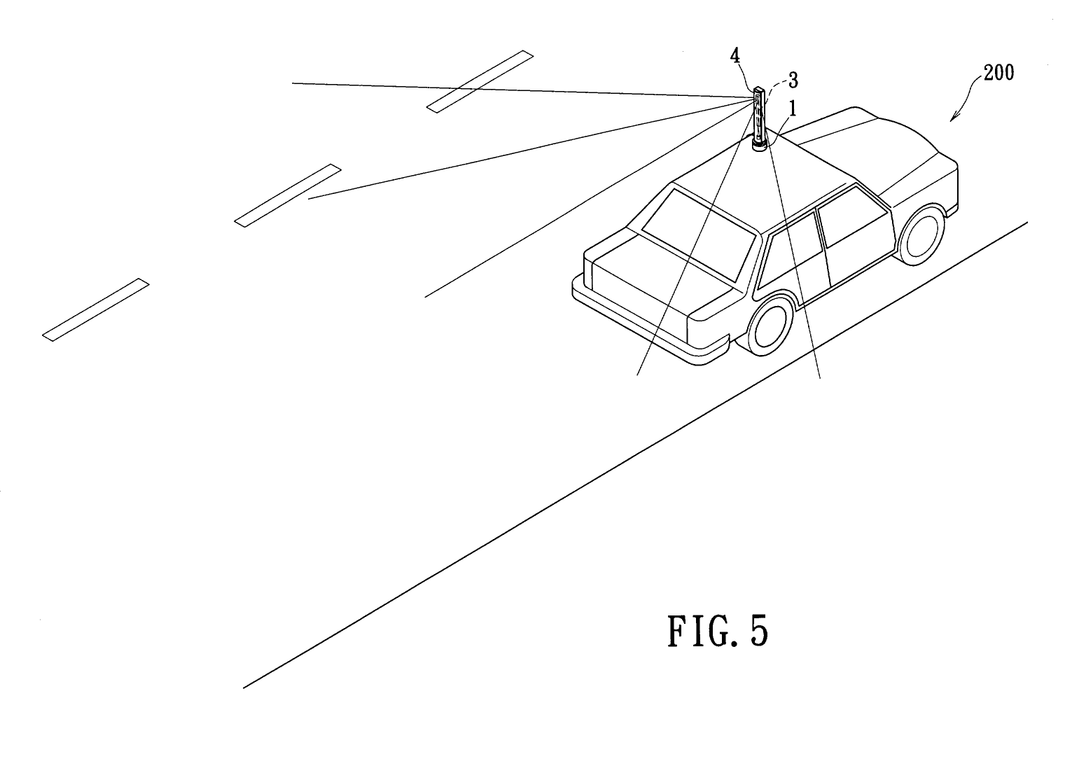

As shown in FIG. 5, the breakdown alarm lamp of car of the present invention makes use of the magnet 14 to adhere to the broken-down car 200 and stand erect thereon. The light source 3 emits out light to alarm rear cars to achieve the alarming effect.

To sum up, the present invention has the following characteristics.

1. The light source 3 can emit out high-brightness light itself to have a better alarming effect without the need of illumination of light from rear cars. Especially, the alarming effect can also be accomplished when used at a road turn.

2. The light, source 3 can still emit out high-brightness light itself when it rains, snows or fogs. Therefore, a better alarming effect not affected by the weather can similarly be accomplished.

3. When the breakdown alarm lamp of car of the present invention is used, it is directly placed on the broken-down car 200 and makes use of the magnet 14 to adhere to the car 200, hence facilitating placement thereof.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A convenience high-brightness breakdown alarm lamp of car, comprising:
a base;
a circuit unit disposed in said base;
a light source electrically connected to said circuit unit so that the required electricity can be provided for said light source; and
a lampshade made of transparent material, said lampshade being connected with said base, said light source being received in said lampshade.

2. The convenience high-brightness breakdown alarm lamp of car as claimed in claim 1, wherein a magnet is disposed at said base.

3. The convenience high-brightness breakdown alarm lamp of car as claimed in claim 1, wherein said base comprises a housing and a cover body, said housing and said cover body are assembled together, and adhesive injection is performed between said housing and said cover body.

4. The convenience high-brightness breakdown alarm lamp of car as claimed in claim 1, wherein an assembly hole is disposed at said base, and one end of said lampshade is inserted and fixed in said assembly hole of said base.

5. The convenience high-brightness breakdown alarm lamp of car as claimed in claim 1, wherein a line-out hole is disposed at said base, said circuit unit comprises a circuit board and a power line, said circuit board is disposed in said base, one end of said power line is electrically connected to said circuit board, the other end of said power line protrudes from said line-out hole of sad base, and the other end of said power line is also connected to a car lighter plug.

6. The convenience high-brightness breakdown alarm lamp of car as claimed in claim 5, wherein a bushing is slipped outside said power line.

7. The convenience high-brightness breakdown alarm lamp of car as claimed in claim 1, wherein said light source is of a “!” shape.
